(19) United States
(12) Patent Application Publication
(10) Pub. No.: US 2020/0072062 A1
(43) Pub. Date: Mar. 5, 2020

(54) System and Method for Airfoil Vibration Control

(71) Applicant: General Electric Company, Schenectady, NY (US)

(72) Inventors: Carl Lawrence MacMahon, Cincinnati, OH (US); Douglas Loren Washburn, Loveland, OH (US)

(21) Appl. No.: 16/118,503

(22) Filed: Aug. 31, 2018

(51) Int. Cl. F01D 5/26; F01D 9/02; F01D 25/06; F01D 5/28; F16F 15/00; F16F 15/18; H01F 1/14; H02K 7/18

(52) U.S. Cl. CPC F01D 5/26; F16F 2222/06; F01D 25/06; F01D 5/282; F16F 15/002; F16F 15/18; H01F 1/14; H02K 7/1823; F05D 2220/32; F05D 2240/122; F05D 2240/24; F05D 2300/11; F05D 2240/303; F05D 2260/96; F05D 2270/334; F05D 2270/44; F01D 9/02

(57) ABSTRACT

A system for airfoil vibration control is generally provided. The system includes an airfoil including a ferromagnetic material, and a static structure including an electromagnet adjacent to the ferromagnetic material of the airfoil. A method for controlling vibration at an airfoil of a turbo machine is further provided. The method includes placing a ferromagnetic material at the airfoil, placing an electromagnet at a static structure adjacent to the ferromagnetic material at the airfoil, and applying an electromagnetic force to the ferromagnetic material at the airfoil via the electromagnet at the static structure.

### FIELD

The present subject matter relates generally controlling or canceling turbo machine vibrations.

### BACKGROUND

Turbo machines, such as gas turbine engines, include rotor assemblies at which a turbine rotor is coupled to a compressor rotor via a driveshaft. Rotating airfoils, or blades, at these rotors generally include structures to avoid synchronous vibrations, or vibrations at the airfoils due to aerodynamic excitation forces occurring at one or more engine orders (i.e., integer multiples of rotational speed of the airfoil). Such aerodynamic excitation may be due to wakes upstream of the airfoil, such as due to stationary airfoils, or stators, struts, combustion processes, or inlet distortion (i.e., altered or asymmetric inlet geometry), or flutter.

Turbo machines are further challenged to withstand or mitigate flow instabilities due to vortex shedding, unsteady flow separations, or unsteady tip clearance flows. Such flow instabilities appear at distinct frequencies different from engine orders and may interact with a natural frequency of the airfoil, such as to result in nonsynchronous vibrations.

Synchronous and nonsynchronous vibrations can promote structural deterioration at the airfoil that may ultimately lead to blade fracture, or reduce a period of time before which the turbo machine necessitates costly service, overhaul, or repair.

Known methods and structures for avoiding synchronous and nonsynchronous vibrations include adding airfoil geometry (e.g., thickness), weight, or other features that generally compromise or otherwise penalize aerodynamic performance of the rotating airfoil. Such compromises may generally decrease turbo machine efficiency in pursuit of improved operability and structural life.

Additionally, understanding of vibrations at the turbo machine, such as nonsynchronous vibrations, may be limited during turbo machine and blade design. Such understanding of which frequencies, rotor speeds, or aerodynamic conditions at which undesired vibrations may occur may generally be understood during turbo machine testing. Although understanding the conditions at which such undesired vibrations may occur during testing enables design changes to mitigate or eliminate such vibrations or deteriorations to the airfoil, such design changes may be costly and nonetheless result in compromises or other penalties adversely affecting turbo machine operability and performance. Still further, such understanding during turbo machine testing may be partial, resulting in further and more costly understanding, re-design, fixes, or replacement, once the turbo machine is in operation by an end user.

As such, there is a need for systems and methods for avoiding synchronous and nonsynchronous vibrations at turbo machine blades, such that the systems may mitigate or eliminate compromises to turbo machine operability, performance, and cost.

### BRIEF DESCRIPTION

Aspects and advantages of the invention will be set forth in part in the following description, or may be obvious from the description, or may be learned through practice of the invention.

An aspect of the present disclosure is directed to a system for airfoil vibration control. The system includes an airfoil including a ferromagnetic material, and a static structure including an electromagnet adjacent to the ferromagnetic material of the airfoil.

In various embodiments, the static structure includes a stator airfoil directly adjacent to the airfoil. In one embodiment, the electromagnet is disposed at a trailing edge tip of the static structure comprising the stator airfoil.

In still various embodiments, the static structure includes a casing surrounding the airfoil. In one embodiment, the electromagnet is disposed at the static structure including the casing at least partially forward of a leading edge tip of the airfoil.

In still yet various embodiments, the airfoil includes a first material at least partially surrounding the ferromagnetic material. In one embodiment, the first material includes a composite material.

In various embodiments, the airfoil includes a first material at least partially surrounding the ferromagnetic material. In one embodiment, the ferromagnetic material includes a plurality of particles within the first material of the airfoil. In another embodiment, the ferromagnetic material includes a unitary structure or a plurality of structures at or within the first material of the airfoil. In one embodiment, the ferromagnetic material defines a plurality of structures defining one or more cross sectional areas at the airfoil.

In one embodiment, the ferromagnetic material is disposed at least at a leading edge tip of the airfoil.

In another embodiment, the ferromagnetic material is disposed between a tip and approximately 35% of a span of the airfoil. In another embodiment, the ferromagnetic material is disposed within 50% or greater span of the airfoil. In yet another embodiment, the ferromagnetic material is disposed within 75% or greater span of the airfoil. In still yet another embodiment, the ferromagnetic material may be disposed within 85% or greater span of the airfoil. In still yet another embodiment, the ferromagnetic material is disposed between approximately 50% and approximately 100% of the span of the airfoil.

In yet another embodiment, the ferromagnetic material is disposed between a leading edge and approximately 50% of a chord of the airfoil. In one embodiment, the ferromagnetic material may be disposed within 25% or less of the chord of the airfoil. In still another embodiment, the ferromagnetic material may be disposed within 15% or less of the chord of the airfoil. In still yet another embodiment, the ferromagnetic material is disposed between approximately 5% and approximately 50% of the chord of the airfoil.

In various embodiments, the system further includes a controller configured to apply an electromagnetic force to the airfoil via the electromagnet of the static structure. In one embodiment, the controller applies the electromagnetic force 180 degrees out of phase to an excitation force of the airfoil.

Another aspect of the present disclosure is directed to a method for controlling vibration at an airfoil of a turbo machine. The method includes placing a ferromagnetic material at the airfoil; placing an electromagnet at a static structure adjacent to the ferromagnetic material at the airfoil; and applying an electromagnetic force to the ferromagnetic material at the airfoil via the electromagnet at the static structure.

In various embodiments, the method further includes modulating the electromagnetic force to be approximately 180 degrees out of phase to an excitation force at the airfoil. In one embodiment, modulating the electromagnetic force to be approximately 180 degrees out of phase is based at least on a predetermined table, chart, or schedule of rotor assembly rotational speed versus airfoil vibrational frequency. In another embodiment, the method further includes measuring vibrations at the static structure adjacent to the airfoil. In yet another embodiment, the method further includes measuring vibrations at the airfoil.

Yet another aspect of the present disclosure is directed to a gas turbine engine. The engine includes a rotor assembly including an airfoil in which the airfoil includes a ferromagnetic material. The engine further includes a static structure including an electromagnet adjacent to the ferromagnetic material of the airfoil. The engine further includes a controller configured to perform operations. The operations include applying an electromagnetic force to the ferromagnetic material at the airfoil via the electromagnet at the static structure; and modulating the electromagnetic force to be approximately 180 degrees out of phase to an excitation force at the airfoil.

In one embodiment, modulating the electromagnetic force to be approximately 180 degrees out of phase is based at least on a predetermined table, chart, or schedule of airfoil rotational speed versus airfoil vibrational frequency.

In another embodiment, modulating the electromagnetic force to be approximately 180 degrees out of phase is based on a vibrational measurement at the static structure, the rotor assembly, or both.

In still another embodiment, a plurality of the electromagnet is disposed in asymmetric circumferential arrangement around a rotor assembly rotational axis.

In yet another embodiment, a plurality of the electromagnet is disposed in axisymmetric circumferential arrangement around a rotor assembly rotational axis.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a cross sectional view of an exemplary turbo machine including a system for controlling airfoil vibrations according to an aspect of the present disclosure;

FIGS. 2-3 are schematic cross sectional views of exemplary embodiments of the system depicted in regard to FIG. 1;

FIGS. 4-8 are schematic cross sectional views of exemplary arrangements of the system depicted in regard to FIGS. 1-3;

FIGS. 9-11 are perspective views of exemplary embodiments of a airfoil of the system depicted in regard to FIGS. 1-8; and

FIG. 12 is a flowchart outlining steps of a method for controlling airfoil vibrations.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

Approximations recited herein may include margins based on one more measurement devices as used in the art, such as, but not limited to, a percentage of a full scale measurement range of a measurement device or sensor. Alternatively, approximations recited herein may include margins of 10% of an upper limit value greater than the upper limit value or 10% of a lower limit value less than the lower limit value.

Embodiments of systems and methods for avoiding synchronous and nonsynchronous vibrations at turbo machine blades are generally provided. Such systems and methods provided herein may mitigate or eliminate compromises to turbo machine operability, performance, and cost. The systems and methods generally provided herein include a rotary airfoil (e.g., blade) or stationary airfoil (e.g., vane) including a ferromagnetic material, and an electromagnet system at a static structure proximate to the ferromagnetic material of the airfoil. An electromagnetic force is applied to the airfoil via the electromagnet at the static structure and the ferromagnetic material of the airfoil. The force is applied 180 degrees out of phase to the excitation force at the airfoil such as to control the vibration amplitude at the airfoil.

As such, the embodiments of the system and method provided herein may reduce or eliminate synchronous or nonsynchronous vibration responses at the airfoil. Systems and methods provided herein further enable modulating or adjusting the electromagnetic force from the electromagnet such as to affect the vibration amplitude at any number of phases, such as corresponding to rotational speed of the rotor assembly, or changes in flow conditions upstream of the airfoil. For example, changes in flow conditions may include changes in aerodynamic conditions or flow stability, such as due to vortex shedding, unsteady flow separations, or unsteady tip clearance flows, wakes upstream of the airfoil due to struts, stators, changes in combustion processes, inlet distortion, or flutter, or changes in variable vane angle, or changes in temperature and pressure generally.

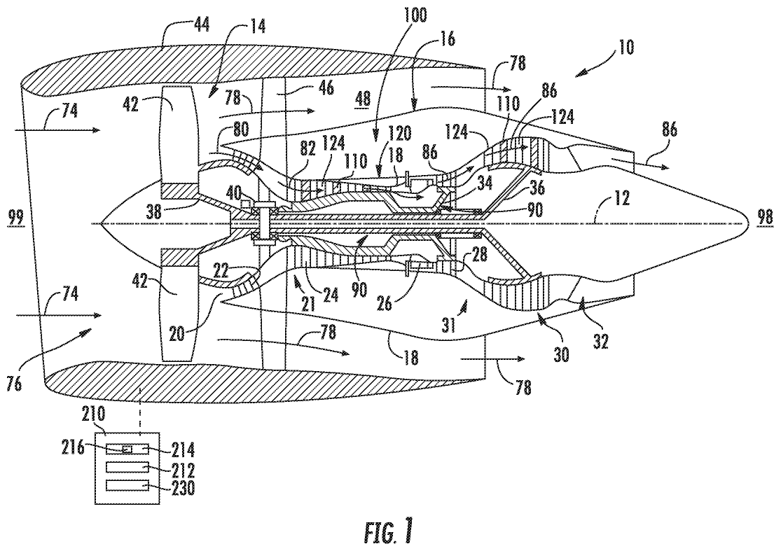

Referring now to the drawings, FIG. 1 is a schematic partially cross-sectioned side view of an exemplary turbo machine 10 herein referred to as “engine 10” as may incorporate various embodiments of the present invention. Although further described herein as a turbofan engine, the engine 10 may define a turboshaft, turboprop, or turbojet gas turbine engine, including marine and industrial engines and auxiliary power units. As shown in FIG. 1, the engine 10 has a longitudinal or axial centerline axis 12 that extends therethrough for reference purposes. An axial direction A is extended co-directional to the axial centerline axis 12 for reference. The engine 10 further defines an upstream end 99 and a downstream end 98 for reference. In general, the engine 10 may include a fan assembly 14 and a core engine 16 disposed downstream from the fan assembly 14.

The core engine 16 may generally include a substantially tubular outer casing 18 that defines a core inlet 20 to a core flowpath 70. The outer casing 18 encases or at least partially forms the core engine 16. The outer casing 18 encases or at least partially forms, in serial flow relationship, a compressor section 21 having a booster or low pressure (LP) compressor 22, a high pressure (HP) compressor 24, a combustion section 26, a turbine section 31 including a high pressure (HP) turbine 28, a low pressure (LP) turbine 30 and a jet exhaust nozzle section 32. A high pressure (HP) rotor shaft 34 drivingly connects the HP turbine 28 to the HP compressor 24. A low pressure (LP) rotor shaft 36 drivingly connects the LP turbine 30 to the LP compressor 22. The LP rotor shaft 36 may also be connected to a fan shaft 38 of the fan assembly 14. In particular embodiments, as shown in FIG. 1, the LP rotor shaft 36 may be connected to the fan shaft 38 via a reduction gear 40 such as in an indirect-drive or geared-drive configuration.

As shown in FIG. 1, the fan assembly 14 includes a plurality of fan blades 42 that are coupled to and that extend radially outwardly from the fan shaft 38. An annular fan casing or nacelle 44 circumferentially surrounds the fan assembly 14 and/or at least a portion of the core engine 16. It should be appreciated by those of ordinary skill in the art that the nacelle 44 may be configured to be supported relative to the core engine 16 by a plurality of circumferentially-spaced outlet guide vanes or struts 46. Moreover, at least a portion of the nacelle 44 may extend over an outer portion of the core engine 16 so as to define a bypass airflow passage 48 therebetween.

It should be appreciated that combinations of the shaft 34, 36, the compressors 22, 24, and the turbines 28, 30 define a rotor assembly 90 of the engine 10. For example, the HP shaft 34, HP compressor 24, and HP turbine 28 may define an HP rotor assembly of the engine 10. Similarly, combinations of the LP shaft 36, LP compressor 22, and LP turbine 30 may define an LP rotor assembly of the engine 10. Various embodiments of the engine 10 may further include the fan shaft 38 and fan blades 42 as the LP rotor assembly. In other embodiments, the engine 10 may further define a fan rotor assembly at least partially mechanically de-coupled from the LP spool via the fan shaft 38 and the reduction gear 40. Still further embodiments may further define one or more intermediate rotor assemblies defined by an intermediate pressure compressor, an intermediate pressure shaft, and an intermediate pressure turbine disposed between the LP rotor assembly and the HP rotor assembly (relative to serial aerodynamic flow arrangement).

During operation of the engine 10, a flow of air, shown schematically by arrows 74, enters an inlet 76 of the engine 10 defined by the fan case or nacelle 44. A portion of air, shown schematically by arrows 80, enters the flowpath 70 at the core engine 16 through the core inlet 20 defined at least partially via the casing 18. The flow of air 80 is increasingly compressed as it flows across successive stages of the compressors 22, 24, such as shown schematically by arrows 82. The compressed air 82 enters the combustion section 26 and mixes with a liquid or gaseous fuel and is ignited to produce combustion gases 86. The combustion gases 86 release energy to drive rotation of the HP rotor assembly and the LP rotor assembly before exhausting from the jet exhaust nozzle section 32. The release of energy from the combustion gases 86 further drives rotation of the fan assembly 14, including the fan blades 42. A portion of the air 74 bypasses the core engine 16 and flows across the bypass airflow passage 48, such as shown schematically by arrows 78.

Referring still to FIG. 1, the engine 10 includes a system for airfoil vibration control, hereinafter referred to as “system 100”. The system 100 includes an airfoil 110 including a ferromagnetic material 112. The system 100 further includes a static structure 120 including an electromagnet 122 disposed adjacent to the ferromagnetic material 112 of the airfoil 110. In one embodiment, the airfoil 110 defines a rotary airfoil or blade coupled to the rotor assembly 90. In other embodiments, the airfoil 110 defines a stationary airfoil (e.g., stator, variable vane, etc.).

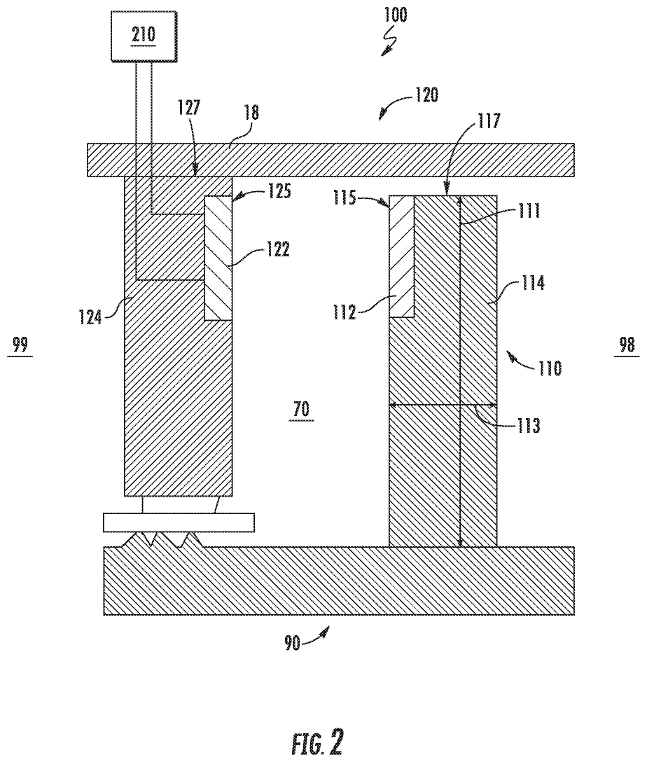

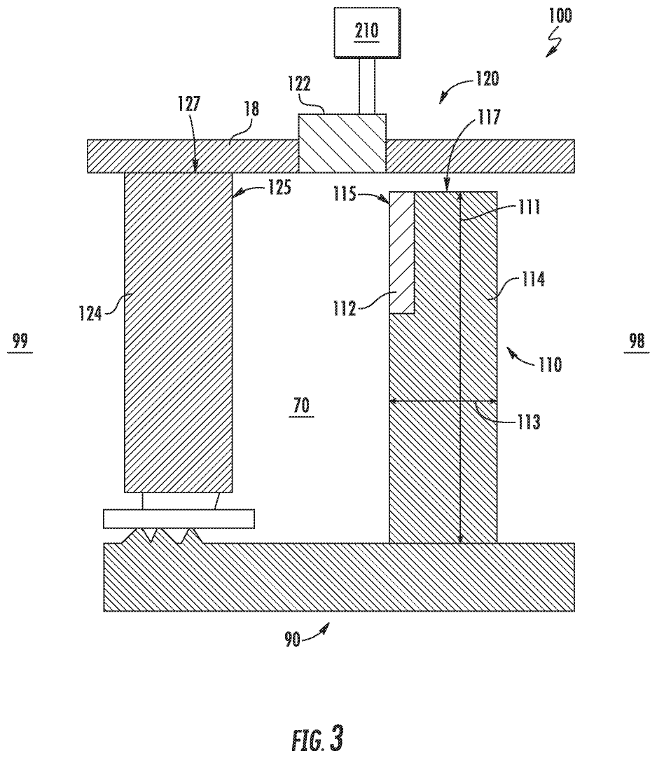

In various embodiments, such as further depicted in regard to FIGS. 2-3, the ferromagnetic material 112 includes one or more of Co, Fe, Fe₂O₃, NiOFe₂O₃, CuO Fe₂O₃, MgOFe₂O₃, MnBi, Ni, MnSb, MnOFe₂O₃, Y₂FeO₁₂, CrO₂, MnAs, Gd, Tb, Dy, EuO, or combinations thereof, or one or more other suitable ferromagnetic materials.

In still various embodiments, such as depicted in regard to FIGS. 1-3, the ferromagnetic material 112 at the airfoil 110 is disposed at a leading edge 115 and/or tip 117 of the airfoil 110. The ferromagnetic material 112 at the airfoil 110 is disposed axially adjacent (FIG. 2), radially adjacent (FIG. 3), or both, (FIG. 1) to the electromagnet 122 at the static structure 120. In one embodiment, the ferromagnetic material 112 is disposed at a tip 117 of the airfoil 110. For example, in one embodiment, the ferromagnetic material 112 may be disposed within 35% or greater span 111 of the airfoil 110 (i.e., the portion of the airfoil 110 more proximate to a static structure 120 including the casing 18 surrounding the airfoil 110). In another embodiment, the ferromagnetic material 112 may be disposed within 50% or greater span 111 of the airfoil 110. As another example, the ferromagnetic material 112 may be disposed within 75% or greater span 111 of the airfoil 110. As yet another example, the ferromagnetic material 112 may be disposed within 85% or greater span 111 of the airfoil 110. In still yet another embodiment, the ferromagnetic material 112 is disposed between approximately 50% and approximately 100% of the span 111 of the airfoil 110.

In yet various embodiments, such as depicted in regard to FIGS. 1-3, the ferromagnetic material 112 is disposed at the leading edge 115 of the airfoil 110 within 50% of a chord 113 of the airfoil 110 (i.e., the portion of the airfoil 110 more proximate to the static structure 120 including a stator 124 directly upstream of the airfoil 110). As another example, the ferromagnetic material 112 may be disposed within 25% or less of the chord 113 of the airfoil 110. As yet another example, the ferromagnetic material 112 may be disposed within 15% or less of the chord 113 of the airfoil 110. In still yet another embodiment, the ferromagnetic material 112 is disposed between approximately 5% and approximately 50% of the chord 113 of the airfoil 110.

It should be appreciated that various embodiments of the system 100 including the airfoil 110 may dispose the ferromagnetic material 112 within or around the airfoil 110 corresponding to deflection, deformation, or stresses at the airfoil 110. For example, the ferromagnetic material 112 may be disposed at the airfoil 110 based at least on a range of rotational speeds of the rotor assembly 90 (e.g., including embodiments of the airfoil 110 coupled to the rotor assembly 90), aerodynamic conditions (e.g., temperature, pressure, flow rate, wakes, vortices, boundary layer conditions generally, etc.), or other structural or aerodynamic forces at the airfoil 110 during one or more operating conditions of the rotor assembly 90 and engine 10.

Referring back to FIG. 2, in one embodiment, the static structure 120 is a stationary airfoil or stator 124 (e.g., a static or variable vane, a strut, etc.). The static structure 120 including the stator 124 is disposed directly adjacent to the airfoil 110 along a flowpath 70 of the engine 10 (FIG. 1). For example, the static structure 120 including the stator 124 may be disposed directly upstream of the airfoil 110. In various embodiments, such as depicted in regard to FIG. 2, the electromagnet 122 is disposed at a trailing edge 125 of the static structure 120 including the stator 124. In still various embodiments, the electromagnet 122 is disposed at a radially outward end 127 of the stator 124, such as corresponding to disposition of the ferromagnetic material 122 within the airfoil 110 adjacent to the static structure 120.

Referring now to FIG. 3, in another embodiment, the static structure 120 at which the electromagnet 122 is disposed is the casing 18 surrounding the airfoil 110. The electromagnet 122 may generally be disposed radially outward of the airfoil 110, such as radially outward of the ferromagnetic material 112 at the airfoil 110. In another embodiment, the electromagnet may be disposed at least partially forward or upstream of the airfoil 110.

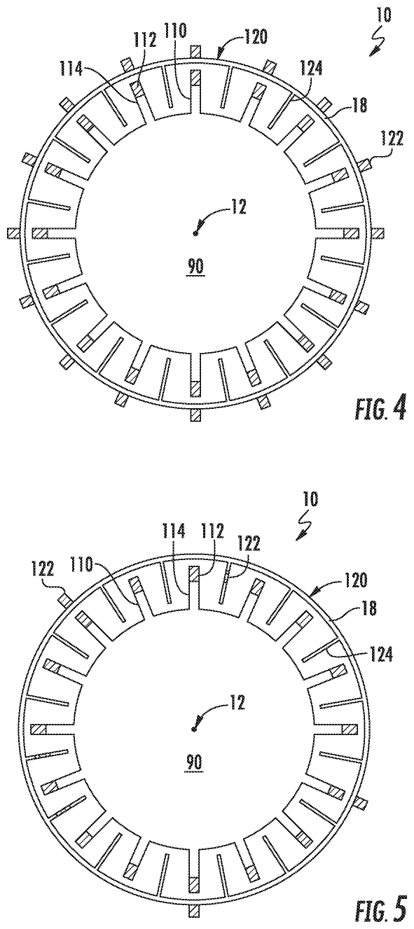

It should be appreciated that various embodiments of the system 100 may dispose the electromagnet 122 at the static structure 120 corresponding to a desired magnitude and direction or vector desired to counteract, interfere, or otherwise offset forces due to synchronous or nonsynchronous vibrations at the airfoil 110. Referring briefly to FIG. 4, for example, a plurality of the electromagnet 122 may be disposed in substantially axisymmetric and circumferential arrangement around the airfoils 110. In another embodiment, such as provided in regard to FIG. 5, a plurality of the electromagnet 122 may be disposed in substantially asymmetric circumferential arrangement around the airfoils 110.

In still another embodiment, such as depicted in regard to FIG. 6, the system 100 may include a first electromagnet 122 and a second electromagnet 222. In one embodiment, the first electromagnet 122 may be disposed at the static structure 120 defining the stator 124 and the second electromagnet 222 may be disposed at the static structure defining the casing 18. In another embodiment, the first electromagnet 122 and the second electromagnet 222 may each be disposed at either the stator 124 or the casing 18. Each electromagnet 122, 222 may be configured to apply an electromagnetic force corresponding to one or more different ranges of synchronous and/or nonsynchronous vibrations that may occur at the airfoil 110.

For example, the first electromagnet 122 may be configured to apply the electromagnetic force to the airfoil 110 based on a first range of operating conditions of the engine 10, such as to affect the vibration amplitude at a first range of phases, such as corresponding to a first range of rotational speed of the rotor assembly 90 (e.g., including embodiments of the airfoil 110 coupled to the rotor assembly 90), or a first range of changes in flow conditions upstream of the airfoil 110. The second electromagnet 222 may be configured to apply the electromagnetic force to the airfoil based on a second range of operating conditions of the engine 10 at least partially different from the first range of operating conditions.

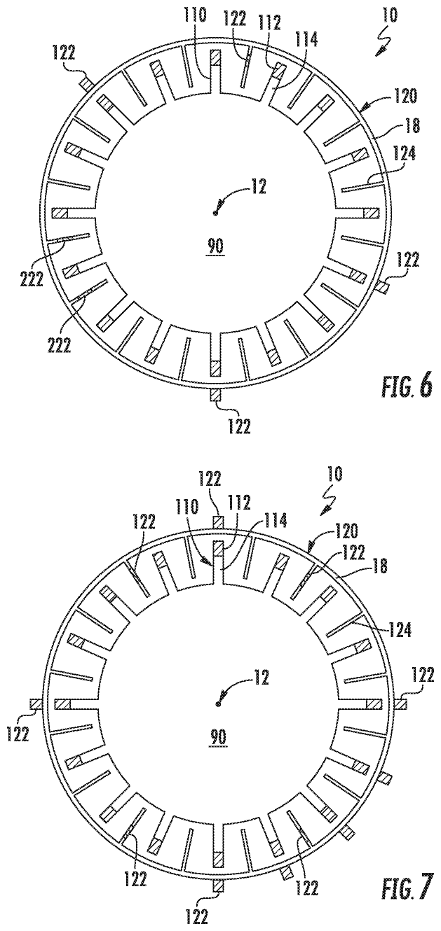

In yet another embodiment, such as depicted in regard to FIG. 7, the system 100 may include the ferromagnetic material 112 disposed in asymmetric arrangement relative to the axial centerline axis 12, or relative to the positioning of the electromagnets 122. It should be appreciated that although FIG. 7 depicts the ferromagnetic material 112 disposed in asymmetric arrangement proximate to the electromagnet 122, in another embodiment the system 100 may include the ferromagnetic material 112 disposed in asymmetric arrangement proximate to the first electromagnet 122 and the second electromagnet 222, such as described in regard to FIG. 6.

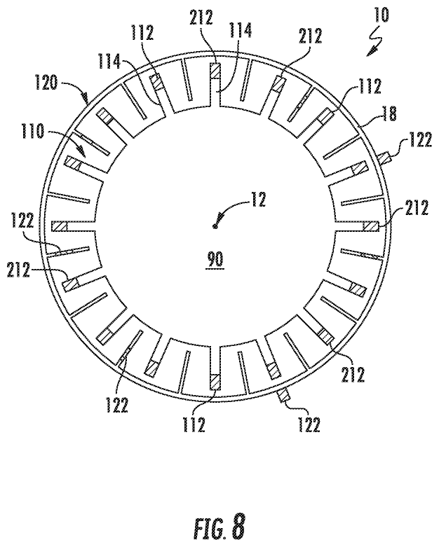

In still yet another embodiment, such as depicted in regard to FIG. 8, the system 100 may include a first ferromagnetic material 112 and a second ferromagnetic material 212. In one embodiment, the first ferromagnetic material 112 and the second ferromagnetic material 212 may each be disposed at the airfoil 110 in asymmetric arrangement relative to the axial centerline axis 12. Each ferromagnetic material 112, 212 may be configured to respond to the electromagnetic force from the electromagnets 122 (or, in various embodiments, additionally or alternatively, the second electromagnet 222) corresponding to one or more different ranges of synchronous and/or nonsynchronous vibrations that may occur at the airfoil 110.

It should be appreciated that, in another embodiment, the system 100 may include the first ferromagnetic material 112 and the second ferromagnetic material 212 disposed in asymmetric arrangement proximate to the first electromagnet 122 and the second electromagnet 222, such as described in regard to FIG. 6. It should further be appreciated that, in still another embodiment, the system 100 may include the first and second ferromagnetic material 112, 212 disposed symmetrically at the plurality of airfoils 110.

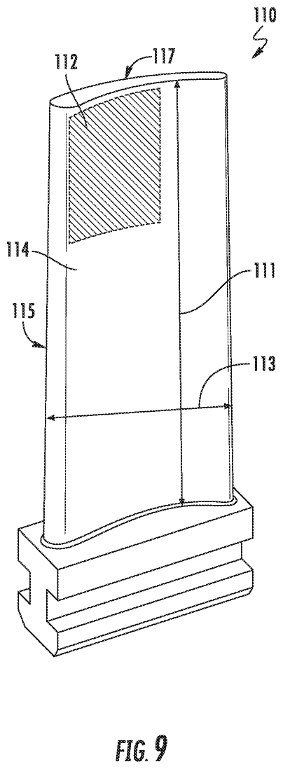

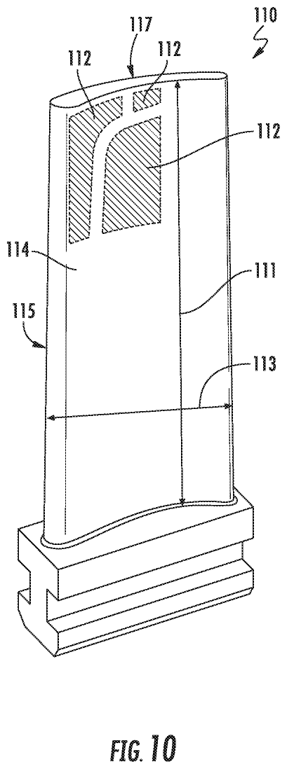

Referring now to FIGS. 9-11, an exemplary embodiment of the ferromagnetic material 112 at the airfoil 110 is generally provided. In various embodiments, the ferromagnetic material 112 is disposed within the airfoil 110 and surrounded by a first material 114. In one embodiment, the first material 114 is a composite material, such as a polymer matrix composite (PMC).

In one embodiment, the first material 114 including the PMC material may include one or more thermoplastic materials. For example, the airfoil 110 including the first material 114 defining the PMC thermoplastic material may include one or more PMC materials defining amorphous thermoplastic materials. The first material 114 defining a PMC amorphous thermoplastic material may include one or more styrenes, vinyls, cellulosics, polyesters, acrylics, polysulphones, imides, or combinations thereof. More specifically, the first material 114 defining the PMC material may include PMC amorphous thermoplastic materials including polystyrene, acrylonitrile butadiene styrene (ABS), polymethyl methacrylate (PMMA), glycolised polyethylene terephthalate (PET-G), polycarbonate, polyvinyl acetate, amorphous polyamide, polyvinyl chlorides (PVC), polyvinylidene chloride, polyurethane, or any other suitable amorphous thermoplastic material, or combinations thereof.

In still various embodiments, the airfoil 110 including the first material 114 defining the PMC thermoplastic material may include one or more PMC materials defining semi-crystalline thermoplastic materials. The first material 114 defining a PMC semi-crystalline thermoplastic material may include one or more polyolefins, polyamides, fluropolymer, ethyl-methyl acrylate, polyesters, polycarbonates, acetals, or combinations thereof. More specifically, the first material 114 defining the PMC material may include PMC semi-crystalline thermoplastic materials including polybutylene terephthalate (PBT), polyethylene terephthalate (PET), polypropylene, polyphenyl sulfide, polyethylene, polyamide (nylon), polyetherketone, or any other suitable semi-crystalline thermoplastic material, or combinations thereof.

In still various embodiments, the airfoil 110 including the first material 114 defining the PMC material may include one or more thermoset materials. For example, the first material 114 defining the PMC thermoset material may include one or more polyesters, polyurethanes, esters, epoxies, or any other suitable thermoset material, or combinations thereof.

It should be appreciated that in other embodiments, the airfoil 110 may include the first material 114 defining a metal or metal matrix composite (MMC) including one or more materials suitable for the airfoil 110 and rotor assembly 90 of the engine 10, such as, but not limited to, nickel or nickel-based alloys, aluminum or aluminum-based alloys, titanium or titanium-based alloys, or one or more materials including continuous reinforcement monofilament fibers or discontinuous reinforcement short fibers or particles, including materials such as carbon fibers, silicon carbide, alumina, or other appropriate composite reinforcement materials. The airfoil 110 including the first material 114 defining a metal, or other suitable airfoil material, and the ferromagnetic material 112 therein may be formed via one or more processes including additive manufacturing or 3D printing. Other embodiments may form the airfoil 110 via one or more machining processes, forgings, castings, or combinations thereof.

In one embodiment, such as depicted in regard to FIG. 9, the ferromagnetic material 112 is a unitary structure within the airfoil 110 surrounded by the first material 114.

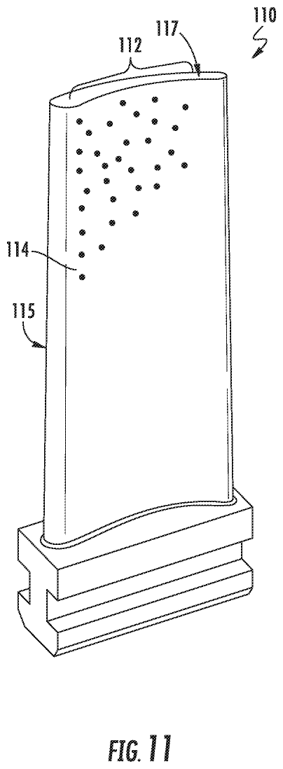

In another embodiment, such as depicted in regard to FIG. 10, the ferromagnetic material 112 is a plurality of structures defining one or more cross sectional areas or shapes within the airfoil 110 surrounded by the first material 114. The plurality of structures defining the ferromagnetic material 112 may be disposed within the leading edge 115 and/or tip 117 of the airfoil 110 based on a desired counteracting electromagnetic force applied to the airfoil 110 from the electromagnet 122 at the static structure 120.

In yet another embodiment, such as depicted in regard to FIG. 11, the ferromagnetic material 112 is a plurality of particles within the airfoil 110 within the first material 114. In various embodiments, the plurality of particles of the ferromagnetic material 112 may be dispersed within the first material 114 such as to apply the counteracting force to the airfoil 110 to offset deflections or deformations due to synchronous or nonsynchronous vibrations. In still various embodiments, the plurality of particles may vary in size, geometry, density, or material composition such as to produce a desired response or force amplitude at the airfoil 110 based on the applied force from the electromagnet 122.

In still other embodiments of the airfoil 110, the ferromagnetic material 112 may be defined on the first material 114 of the airfoil 110. For example, the airfoil 110, defining a pressure side and a suction side, may define the ferromagnetic material 112 on the first material 114 at the pressure side or the suction side of the airfoil 110. The airfoil 110 may include the ferromagnetic material 112 defining one or more of the unitary structure, the plurality of structures, and/or the plurality of particles, such as described in regard to FIGS. 9-11.

Referring back to FIG. 1, the system 100 may further include a controller 210 configured to apply an electromagnetic force to the airfoil 110 via the electromagnet 122 of the static structure 120. In various embodiments, the controller 210 can generally correspond to any suitable processor-based device, including one or more computing devices. For instance, FIG. 1 illustrates one embodiment of suitable components that can be included within the controller 210. As shown in FIG. 1, the controller 210 can include a processor 212 and associated memory 214 configured to perform a variety of computer-implemented functions. In various embodiments, the controller 210 may be configured to operate the system 100 such as to provide a current or voltage to generate the electromagnetic force at the electromagnet 122 to the ferromagnetic material 112 at the airfoil 110.

As used herein, the term “processor” refers not only to integrated circuits referred to in the art as being included in a computer, but also refers to a controller, microcontroller, a microcomputer, a programmable logic controller (PLC), an application specific integrated circuit (ASIC), a Field Programmable Gate Array (FPGA), and other programmable circuits. Additionally, the memory 214 can generally include memory element(s) including, but not limited to, computer readable medium (e.g., random access memory (RAM)), computer readable non-volatile medium (e.g., flash memory), a compact disc-read only memory (CD-ROM), a magneto-optical disk (MOD), a digital versatile disc (DVD) and/or other suitable memory elements or combinations thereof. In various embodiments, the controller 210 may define one or more of a full authority digital engine controller (FADEC), a propeller control unit (PCU), an engine control unit (ECU), or an electronic engine control (EEC).

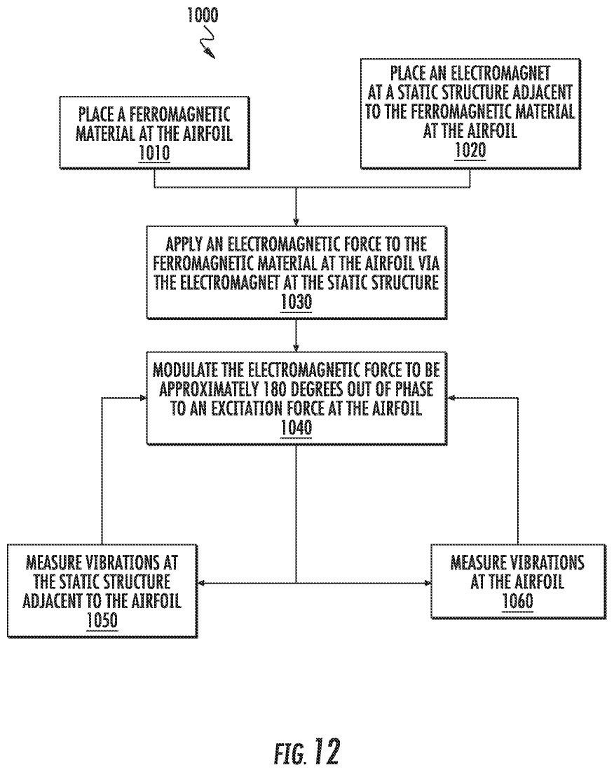

As shown, the controller 210 may include control logic 216 stored in memory 214. The control logic 216 may include instructions that when executed by the one or more processors 212 cause the one or more processors 212 to perform operations, such as steps of a method for controlling vibrations at an airfoil (hereinafter, “method 1000”) outlined in regard to FIG. 12 and further described in regard to the engine 10, system 100, blade 110, and static structure 120 shown and depicted in FIGS. 1-11.

In various embodiments, the controller 210 may include at the memory 214 a predetermined table, chart, schedule, function, transfer or feedback function, etc. of rotational speed of the rotor assembly 90 versus vibrational frequency at the airfoil 110. In one embodiment, the controller 210 may include at the memory 214 the predetermined table, etc. of rotational speed of the airfoil 110 at the rotor assembly 90 defining a rotary airfoil or blade versus vibrational frequency at the airfoil 110. It should be appreciated that “rotational speed” used herein may include a corrected rotational speed, such as based on temperature, pressure, density, etc. of the fluid (e.g., air) through which the rotor assembly 90 is rotating. In another embodiment, the predetermined table of rotational speed versus frequency may include data based at least on prior operation of the engine 10, or operation of similar engines, such as those of a similar model, fleet, etc.

Additionally, as shown in FIG. 1, the controller 210 may also include a communications interface module 230. In various embodiments, the communications interface module 230 can include associated electronic circuitry that is used to send and receive data. As such, the communications interface module 230 of the controller 210 can be used to receive data from the engine 10, such as, but not limited to, a vibrations measurement at the airfoil 110 and/or static structure 120. In one embodiment, the communications module 230 of the controller 210 can be used to receive a frequency or amplitude measurement at the airfoil 110, a rotational speed at the rotor assembly 90, or more particularly a rotational speed at the airfoil 110 defined at the rotor assembly 90, or a current or voltage measurement at the electromagnet 122 of the static structure 120 indicating an electromagnetic force applied to the airfoil 110. In various embodiments, the vibrations measurement may include a strain measurement, an accelerometer, or a non-contact or non-interference structural measurement at the airfoil 110 defining a rotary airfoil at the rotor assembly 90, such as a blade tip timing measurement.

In addition, the communications interface module 230 can also be used to communicate with any other suitable components of the system 90 or the engine 10, such as to receive data or send commands to/from any number of valves, vane assemblies, fuel systems, rotor assemblies, ports, etc. controlling speed, temperature, pressure, or flow rate at the engine 10.

It should be appreciated that the communications interface module 230 can be any combination of suitable wired and/or wireless communications interfaces and, thus, can be communicatively coupled to one or more components of the system 100 via a wired and/or wireless connection. As such, the controller 210 may operate, modulate, or adjust operation of the system 100, such as to modulate the electromagnetic force applied to the airfoil 110 to be approximately 180 degrees out of phase to an excitation force at the airfoil 110.

Referring now to FIG. 12, an outline of exemplary steps of the method 1000 for controlling vibration at an airfoil of a turbo machine (e.g., blade 110 of the engine 10 depicted in regard to FIGS. 1-11) is generally provided.

The method 1000 includes at 1010 placing a ferromagnetic material at the airfoil; at 1020 placing an electromagnet at a static structure adjacent to the ferromagnetic material at the airfoil; and at 1030 applying an electromagnetic force to the ferromagnetic material at the airfoil via the electromagnet at the static structure, such as shown and described in regard to the engine 10 including the airfoil 110, the static structure 120, and the controller 210 in FIGS. 1-11.

In various embodiments, the method 1000 further includes at 1040 modulating the electromagnetic force to be approximately 180 degrees out of phase to an excitation force at the airfoil. In one embodiment, modulating the electromagnetic force to be approximately 180 degrees out of phase is based at least on a predetermined table, chart, or schedule of rotor assembly rotational speed versus airfoil vibrational frequency.

In another embodiment, the method 1000 further includes at 1050 measuring vibrations at the static structure adjacent to the airfoil. In yet other embodiment, the method 1000 further includes at 1060 measuring vibrations at the airfoil. In one embodiment, measuring vibrations at the airfoil includes measuring vibrations at the airfoil via a non-contact vibration measurement or non-interference vibration measurement at the airfoil. For example, non-contact or non-interference vibration measurement at the airfoil may include timing when the tip 117 of the airfoil 110 passes a particular point along a circumference of the engine 10, comparing the timing to a timing of when another portion of the rotor assembly 90 (e.g., the shaft 34, 36) passes a corresponding particular point along the circumference of the engine 10, and determining deflection, deformation, stress, force, etc. at the airfoil 110 based at least on a difference between timing at the tip 117 of the airfoil 110 and the timing elsewhere at the rotor assembly 90 (e.g., at the shaft 34, 36 to which the airfoil 110 is rotatably coupled).

Embodiments of systems 100 and methods 1000 for avoiding synchronous and nonsynchronous vibrations at turbo machine airfoils generally provided herein may mitigate or eliminate compromises to engine 10 operability, performance, and cost that may otherwise result from structures typically added to airfoils to mitigate or eliminate undesired vibrations. The airfoil 110 generally described and depicted herein enables relaxing of airfoil synchronous vibration crossing requirements by actively controlling the resonant amplitude of vibration at the airfoil 110. As such, the airfoil 110 may generally be thinner in profile, lighter in weight, and/or generally more aerodynamically capable, thereby improving engine performance and operability (e.g., improved specific fuel consumption).

It should further be appreciated that various embodiments of the airfoil 110 shown and described herein may define a rotary airfoil at the fan assembly 14, the compressor section 21, and/or the turbine section 31. In other embodiments, the airfoil 110 shown and described here may define a substantially stationary airfoil (e.g., stator, variable vane, etc.) at the fan assembly 14, the compressor section 21, and/or the turbine section 31. Still further, various embodiments of the static structure 120 shown and described herein may define a stator, variable vane, strut, wall, casing, or other fixed structure surrounding, upstream, or otherwise proximate to the airfoil 110 such as to apply at the ferromagnetic material 112 at the airfoil 110 a sufficient electromagnetic force approximately 180 degrees out of phase to the excitation force.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for airfoil vibration control, the system comprising:
an airfoil comprising a ferromagnetic material; and
a static structure comprising an electromagnet adjacent to the ferromagnetic material of the airfoil.

2. The system of claim 1, wherein the static structure comprises a stator airfoil directly adjacent to the airfoil.

3. The system of claim 2, wherein the electromagnet is disposed at a trailing edge tip of the static structure comprising the stator airfoil.

4. The system of claim 1, wherein the static structure comprises a casing surrounding the airfoil.

5. The system of claim 4, wherein the electromagnet is disposed at the static structure comprising the casing at least partially forward of a leading edge of the airfoil.

6. The system of claim 1, wherein the airfoil comprises a first material at least partially surrounding the ferromagnetic material.

7. The system of claim 6, wherein the ferromagnetic material comprises a plurality of particles within the first material of the airfoil.

8. The system of claim 1, wherein the airfoil comprises a first material comprising a composite material.

9. The system of claim 1, wherein the ferromagnetic material defines a plurality of structures defining one or more cross sectional areas at the airfoil.

10. The system of claim 1, wherein the ferromagnetic material is disposed between a tip and approximately 35% of a span of the airfoil.

11. The system of claim 1, wherein the ferromagnetic material is disposed between a leading edge and approximately 50% of a chord of the airfoil.

12. The system of claim 1, further comprising:
a controller configured to apply an electromagnetic force to the airfoil via the electromagnet of the static structure.

13. The system of claim 12, wherein the controller applies the electromagnetic force 180 degrees out of phase to an excitation force of the airfoil.

14. A method for controlling vibration at an airfoil of a turbo machine, the method comprising:
placing a ferromagnetic material at the airfoil;
placing an electromagnet at a static structure adjacent to the ferromagnetic material at the airfoil; and
applying an electromagnetic force to the ferromagnetic material at the airfoil via the electromagnet at the static structure.

15. The method of claim 14, further comprising:
modulating the electromagnetic force to be approximately 180 degrees out of phase to an excitation force at the airfoil.

16. The method of claim 15, further comprising:
measuring vibrations at the static structure adjacent to the airfoil; or
measuring vibrations at the airfoil.

17. A gas turbine engine, the engine comprising:
a rotor assembly comprising an airfoil, wherein the airfoil comprises a ferromagnetic material;
a static structure comprising an electromagnet adjacent to the ferromagnetic material of the airfoil; and
a controller configured to perform operations, the operations comprising:
applying an electromagnetic force to the ferromagnetic material at the airfoil via the electromagnet at the static structure; and
modulating the electromagnetic force to be approximately 180 degrees out of phase to an excitation force at the airfoil.

18. The gas turbine engine of claim 17, wherein modulating the electromagnetic force to be approximately 180 degrees out of phase is based on a vibrational measurement at the static structure, the rotor assembly, or both.

19. The gas turbine engine of claim 17, wherein a plurality of the electromagnet is disposed in asymmetric circumferential arrangement around a rotor assembly rotational axis.

20. The gas turbine engine of claim 17, wherein a plurality of the electromagnet is disposed in axisymmetric circumferential arrangement around a rotor assembly rotational axis.
